(19) United States
(12) Patent Application Publication
(10) Pub. No.: US 2025/0190114 A1
(43) Pub. Date: Jun. 12, 2025

(54) MODE TRANSITION USING TRANSLATION-EXEMPT MEMORY

(71) Applicant: Micron Technology, Inc., Boise, ID (US)

(72) Inventors: Gaurav Sinha, Unterschleißheim (DE); Marco Redaelli, München (DE)

(21) Appl. No.: 18/778,320

(22) Filed: Jul. 19, 2024

Related U.S. Application Data
(60) Provisional application No. 63/608,592, filed on Dec. 11, 2023.

(51) Int. Cl. G06F 3/06; G06F 12/1009

(52) U.S. Cl. CPC G06F 3/0611; G06F 3/0634; G06F 3/0659; G06F 3/0679; G06F 12/1009

(57) ABSTRACT

Methods, systems, and devices for use of translation-exempt memory for mode transition are described. A memory system with a non-volatile memory may receive operating information associated with a set of operations of a system that includes the memory system. Before entrance into a system suspension state, the memory system may write the operating information to a portion of the non-volatile memory that is accessible by the memory system without using address translation. After exiting the system suspension state, the memory system may transmit the operating information from the non-volatile memory to a host system.

### CROSS REFERENCE

The present application for patent claims priority to U.S. Patent Application No. 63/608,592 by Sinha et al., entitled “MODE TRANSITION USING TRANSLATION-EXEMPT MEMORY,” filed Dec. 11, 2023, which is assigned to the assignee hereof, and which is expressly incorporated by reference in its entirety herein.

### TECHNICAL FIELD

The following relates to one or more systems for memory, including the use of translation-exempt memory for mode transition.

### BACKGROUND

Memory devices are widely used to store information in devices such as computers, user devices, wireless communication devices, cameras, digital displays, and others. Information is stored by programming memory cells within a memory device to various states. For example, binary memory cells may be programmed to one of two supported states, often denoted by a logic 1 or a logic 0. In some examples, a single memory cell may support more than two states, any one of which may be stored. To access the stored information, the memory device may read (e.g., sense, detect, retrieve, determine) states from the memory cells. To store information, the memory device may write (e.g., program, set, assign) states to the memory cells.

Various types of memory devices exist, including magnetic hard disks, random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), self-selecting memory, chalcogenide memory technologies, not-or (NOR) and not-and (NAND) memory devices, and others. Memory cells may be described in terms of volatile configurations or non-volatile configurations. Memory cells configured in a non-volatile configuration may maintain stored logic states for extended periods of time even in the absence of an external power source. Memory cells configured in a volatile configuration may lose stored states when disconnected from an external power source.

### BRIEF DESCRIPTION OF THE DRAWINGS

FIG. 1 shows an example of a system that supports the use of translation-exempt memory for mode transition in accordance with examples as disclosed herein.

FIG. 2 shows an example of a system that supports the use of translation-exempt memory for mode transition in accordance with examples as disclosed herein.

FIG. 3 shows an example of a process flow that supports the use of translation-exempt memory for mode transition in accordance with examples as disclosed herein.

FIG. 4 shows an example of a process flow that supports the use of translation-exempt memory for mode transition in accordance with examples as disclosed herein.

FIG. 5 shows a block diagram of a memory system that supports the use of translation-exempt memory for mode transition in accordance with examples as disclosed herein.

FIG. 6 shows a block diagram of a host system that supports the use of translation-exempt memory for mode transition in accordance with examples as disclosed herein.

FIG. 7 shows a block diagram of a system that supports the use of translation-exempt memory for mode transition in accordance with examples as disclosed herein.

FIGS. 8 through 10 show flowcharts illustrating a method or methods that support use of translation-exempt memory for mode transition in accordance with examples as disclosed herein.

### DETAILED DESCRIPTION

A system (e.g., a system of a car, a system of a mobile phone) may include a host system and a memory system. To facilitate performance of various operations and manage a state of the system, the host system may store operating information in a volatile memory coupled with the host system. Before entering a system suspension state (e.g., a suspend mode in which the operations are suspended), the host system may transfer the operating information to the memory system for storage. But retrieval of the operating information (e.g., upon exit from the system suspension state) from the memory system may involve the memory system initializing an address translation component used to access the non-volatile memory, which in turn may rely on the system performing at least part of an initialization sequence, each of which may increase the latency of retrieval and delay resumption of the suspended operations, thus negatively impacting user experience.

According to the techniques described herein, a system may reduce the latency associated with retrieving information (e.g., operating information) from a memory system by having the memory system store the information in a portion of the non-volatile memory that is accessible by the memory system without address translation. Storing the information in the portion, which may be referred to as a translation-exempt portion, may allow retrieval of the information without initialization of the address translation component, without performing at least part of the initialization sequence for the system, or both, and thus may reduce the latency associated with retrieval relative to other techniques.

In addition to applicability in systems as described herein, techniques for using translation-exempt memory for mode-transition may be generally implemented to improve the performance of various electronic devices and systems (including artificial intelligence (AI) applications, augmented reality (AR) applications, and virtual reality (VR) applications, among others). Some electronic device applications, including high-performance applications such as AI, AR, VR, and gaming, may be associated with relatively high processing requirements to satisfy user expectations. As such, increasing processing capabilities of the electronic devices by decreasing response times, improving power consumption, reducing complexity, increasing data throughput or access speeds, decreasing communication times, or increasing memory capacity or density, among other performance indicators, may improve user experience or appeal. Implementing the techniques described herein may improve the performance of electronic devices by decreasing the latency associated with exiting from a system suspension state, which in turn may improve user experience and performance, among other benefits.

Features of the disclosure are illustrated and described in the context of systems, devices, and circuits. Features of the disclosure are further illustrated and described in the context of a system, process flows, block diagrams, and flowcharts.

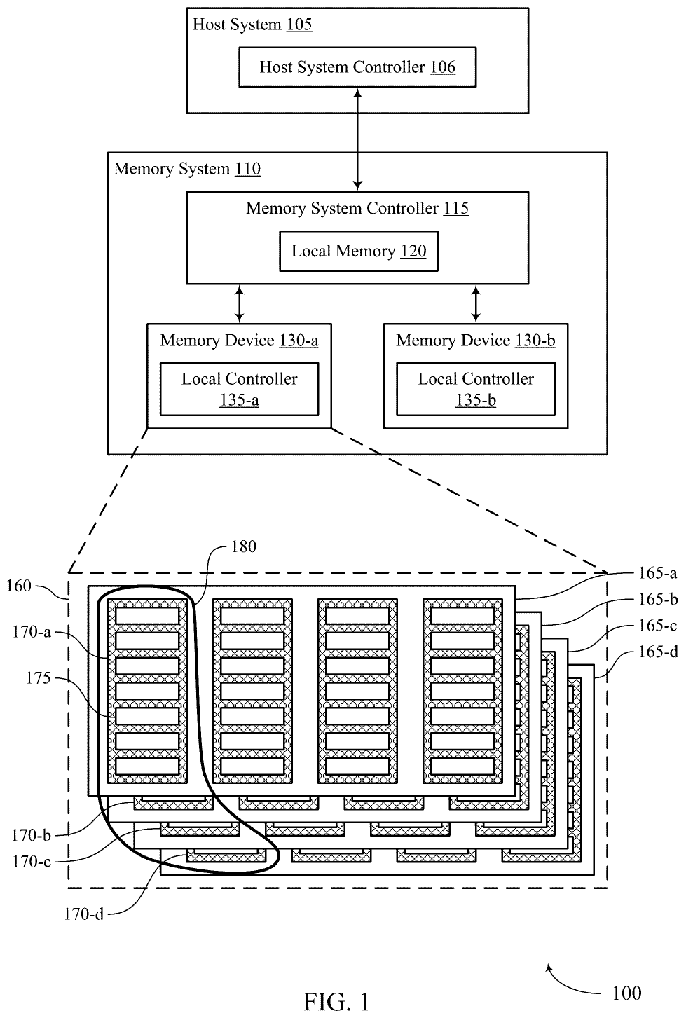

FIG. 1 shows an example of a system 100 that supports the use of translation-exempt memory for mode transition in accordance with examples as disclosed herein. The system 100 includes a host system 105 coupled with a memory system 110. The system 100 may be included in a computing device such as a desktop computer, a laptop computer, a network server, a mobile device, a vehicle (e.g., airplane, drone, train, automobile, or other conveyance), an Internet of Things (IoT) enabled device, an embedded computer (e.g., one included in a vehicle, industrial equipment, or a networked commercial device), or any other computing device that includes memory and a processing device.

A memory system 110 may be or include any device or collection of devices, where the device or collection of devices includes at least one memory array. For example, a memory system 110 may be or include a Universal Flash Storage (UFS) device, an embedded Multi-Media Controller (eMMC) device, a flash device, a universal serial bus (USB) flash device, a secure digital (SD) card, a solid-state drive (SSD), a hard disk drive (HDD), a dual in-line memory module (DIMM), a small outline DIMM (SO-DIMM), or a non-volatile DIMM (NVDIMM), among other devices.

The system 100 may include a host system 105, which may be coupled with the memory system 110. In some examples, this coupling may include an interface with a host system controller 106, which may be an example of a controller or control component configured to cause the host system 105 to perform various operations in accordance with examples as described herein. The host system 105 may include one or more devices and, in some cases, may include a processor chipset and a software stack executed by the processor chipset. For example, the host system 105 may include an application configured for communicating with the memory system 110 or a device therein. The processor chipset may include one or more cores, one or more caches (e.g., memory local to or included in the host system 105), a memory controller (e.g., NVDIMM controller), and a storage protocol controller (e.g., peripheral component interconnect express (PCIe) controller, serial advanced technology attachment (SATA) controller). The host system 105 may use the memory system 110, for example, to write data to the memory system 110 and read data from the memory system 110. Although one memory system 110 is shown in FIG. 1, the host system 105 may be coupled with any quantity of memory systems 110.

The host system 105 may be coupled with the memory system 110 via at least one physical host interface. The host system 105 and the memory system 110 may, in some cases, be configured to communicate via a physical host interface using an associated protocol (e.g., to exchange or otherwise communicate control, address, data, and other signals between the memory system 110 and the host system 105). Examples of a physical host interface may include, but are not limited to, a SATA interface, a UFS interface, an eMMC interface, a PCIe interface, a USB interface, a Fiber Channel interface, a Small Computer System Interface (SCSI), a Serial Attached SCSI (SAS), a Double Data Rate (DDR) interface, a DIMM interface (e.g., DIMM socket interface that supports DDR), an Open NAND Flash Interface (ONFI), and a Low Power Double Data Rate (LPDDR) interface. In some examples, one or more such interfaces may be included in or otherwise supported between a host system controller 106 of the host system 105 and a memory system controller 115 of the memory system 110. In some examples, the host system 105 may be coupled with the memory system 110 (e.g., the host system controller 106 may be coupled with the memory system controller 115) via a respective physical host interface for each memory device 130 included in the memory system 110, or via a respective physical host interface for each type of memory device 130 included in the memory system 110.

The memory system 110 may include a memory system controller 115 and one or more memory devices 130. A memory device 130 may include one or more memory arrays of any type of memory cells (e.g., non-volatile memory cells, volatile memory cells, or any combination thereof). Although two memory devices 130-a and 130-b are shown in the example of FIG. 1, the memory system 110 may include any quantity of memory devices 130. Further, if the memory system 110 includes more than one memory device 130, different memory devices 130 within the memory system 110 may include the same or different types of memory cells.

The memory system controller 115 may be coupled with and communicate with the host system 105 (e.g., via the physical host interface) and may be an example of a controller or control component configured to cause the memory system 110 to perform various operations in accordance with examples as described herein. The memory system controller 115 may also be coupled with and communicate with memory devices 130 to perform operations such as reading data, writing data, erasing data, or refreshing data at a memory device 130—among other such operations—which may generically be referred to as access operations. In some cases, the memory system controller 115 may receive commands from the host system 105 and communicate with one or more memory devices 130 to execute such commands (e.g., at memory arrays within the one or more memory devices 130). For example, the memory system controller 115 may receive commands or operations from the host system 105 and may convert the commands or operations into instructions or appropriate commands to achieve the desired access of the memory devices 130. In some cases, the memory system controller 115 may exchange data with the host system 105 and with one or more memory devices 130 (e.g., in response to or otherwise in association with commands from the host system 105). For example, the memory system controller 115 may convert responses (e.g., data packets or other signals) associated with the memory devices 130 into corresponding signals for the host system 105.

The memory system controller 115 may be configured for other operations associated with the memory devices 130. For example, the memory system controller 115 may execute or manage operations such as wear-leveling operations, garbage collection operations, error control operations such as error-detecting operations or error-correcting operations, encryption operations, caching operations, media management operations, background refresh, health monitoring, and address translations between logical addresses (e.g., logical block addresses (LBAs)) associated with commands from the host system 105 and physical addresses (e.g., physical block addresses) associated with memory cells within the memory devices 130.

The memory system controller 115 may include hardware such as one or more integrated circuits or discrete components, a buffer memory, or a combination thereof. The hardware may include circuitry with dedicated (e.g., hard-coded) logic to perform the operations ascribed herein to the memory system controller 115. The memory system controller 115 may be or include a microcontroller, special purpose logic circuitry (e.g., a field programmable gate array (FPGA), an application specific integrated circuit (ASIC), a digital signal processor (DSP)), or any other suitable processor or processing circuitry.

The memory system controller 115 may also include a local memory 120. In some cases, the local memory 120 may include read-only memory (ROM) or other memory that may store operating code (e.g., executable instructions) executable by the memory system controller 115 to perform functions ascribed herein to the memory system controller 115. In some cases, the local memory 120 may additionally, or alternatively, include static random access memory (SRAM) or other memory that may be used by the memory system controller 115 for internal storage or calculations, for example, related to the functions ascribed herein to the memory system controller 115. Additionally, or alternatively, the local memory 120 may serve as a cache for the memory system controller 115. For example, data may be stored in the local memory 120 if read from or written to a memory device 130, and the data may be available within the local memory 120 for subsequent retrieval for or manipulation (e.g., updating) by the host system 105 (e.g., with reduced latency relative to a memory device 130) in accordance with a cache policy.

Although the example of the memory system 110 in FIG. 1 has been illustrated as including the memory system controller 115, in some cases, a memory system 110 may not include a memory system controller 115. For example, the memory system 110 may additionally, or alternatively, rely on an external controller (e.g., implemented by the host system 105) or one or more local controllers 135, which may be internal to memory devices 130, respectively, to perform the functions ascribed herein to the memory system controller 115. In general, one or more functions ascribed herein to the memory system controller 115 may, in some cases, be performed instead by the host system 105, a local controller 135, or any combination thereof. In some cases, a memory device 130 that is managed at least in part by a memory system controller 115 may be referred to as a managed memory device. An example of a managed memory device is a managed NAND (MNAND) device.

A memory device 130 may include one or more arrays of non-volatile memory cells. For example, a memory device 130 may include NAND (e.g., NAND flash) memory, ROM, phase change memory (PCM), self-selecting memory, other chalcogenide-based memories, ferroelectric random access memory (FeRAM), magneto RAM (MRAM), NOR (e.g., NOR flash) memory, Spin Transfer Torque (STT)-MRAM, conductive bridging RAM (CBRAM), resistive random access memory (RRAM), oxide based RRAM (OxRAM), electrically erasable programmable ROM (EEPROM), or any combination thereof. Additionally, or alternatively, a memory device 130 may include one or more arrays of volatile memory cells. For example, a memory device 130 may include RAM memory cells, such as dynamic RAM (DRAM) memory cells and synchronous DRAM (SDRAM) memory cells.

In some examples, a memory device 130 may include (e.g., on a same die or within the same package) a local controller 135, which may execute operations on one or more memory cells of the respective memory device 130. A local controller 135 may operate in conjunction with a memory system controller 115 or may perform one or more functions ascribed herein to the memory system controller 115. For example, as illustrated in FIG. 1, a memory device 130-a may include a local controller 135-a and a memory device 130-b may include a local controller 135-b.

In some cases, a memory device 130 may be or include a NAND device (e.g., NAND flash device). A memory device 130 may be or include a die 160 (e.g., a memory die). For example, in some cases, a memory device 130 may be a package that includes one or more dies 160. A die 160 may, in some examples, be a piece of electronics-grade semiconductor cut from a wafer (e.g., a silicon die cut from a silicon wafer). Each die 160 may include one or more planes 165, and each plane 165 may include a respective set of blocks 170, where each block 170 may include a respective set of pages 175, and each page 175 may include a set of memory cells.

In some cases, a NAND memory device 130 may include memory cells configured to each store one bit of information, which may be referred to as single level cells (SLCs). Additionally, or alternatively, a NAND memory device 130 may include memory cells configured to each store multiple bits of information, which may be referred to as multi-level cells (MLCs) if configured to each store two bits of information, as tri-level cells (TLCs) if configured to each store three bits of information, as quad-level cells (QLCs) if configured to each store four bits of information, or more generically as multiple-level memory cells. Multiple-level memory cells may provide greater density of storage relative to SLC memory cells but may, in some cases, involve narrower read or write margins or greater complexities for supporting circuitry.

In some cases, planes 165 may refer to groups of blocks 170 and, in some cases, concurrent operations may be performed on different planes 165. For example, concurrent operations may be performed on memory cells within different blocks 170 so long as the different blocks 170 are in different planes 165. In some cases, an individual block 170 may be referred to as a physical block, and a virtual block 180 may refer to a group of blocks 170 within which concurrent operations may occur. For example, concurrent operations may be performed on blocks 170-a, 170-b, 170-c, and 170-d that are within planes 165-a, 165-b, 165-c, and 165-d, respectively, and blocks 170-a, 170-b, 170-c, and 170-d may be collectively referred to as a virtual block 180. In some cases, a virtual block may include blocks 170 from different memory devices 130 (e.g., including blocks in one or more planes of memory device 130-a and memory device 130-b). In some cases, the blocks 170 within a virtual block may have the same block address within their respective planes 165 (e.g., block 170-a may be “block 0” of plane 165-a, block 170-b may be “block 0” of plane 165-b, and so on). In some cases, performing concurrent operations in different planes 165 may be subject to one or more restrictions, such as concurrent operations being performed on memory cells within different pages 175 that have the same page address within their respective planes 165 (e.g., related to command decoding, page address decoding circuitry, or other circuitry being shared across planes 165).

In some cases, a block 170 may include memory cells organized into rows (pages 175) and columns (e.g., strings, not shown). For example, memory cells in a same page 175 may share (e.g., be coupled with) a common word line, and memory cells in a same string may share (e.g., be coupled with) a common digit line (which may alternatively be referred to as a bit line).

For some NAND architectures, memory cells may be read and programmed (e.g., written) at a first level of granularity (e.g., at a page level of granularity, or portion thereof) but may be erased at a second level of granularity (e.g., at a block level of granularity). That is, a page 175 may be the smallest unit of memory (e.g., set of memory cells) that may be independently programmed or read (e.g., programed or read concurrently as part of a single program or read operation), and a block 170 may be the smallest unit of memory (e.g., set of memory cells) that may be independently erased (e.g., erased concurrently as part of a single erase operation). Further, in some cases, NAND memory cells may be erased before they can be re-written with new data. Thus, for example, a used page 175 may, in some cases, not be updated until the entire block 170 that includes the page 175 has been erased.

In some cases, to update some data within a block 170 while retaining other data within the block 170, the memory device 130 may copy the data to be retained to a new block 170 and write the updated data to one or more remaining pages of the new block 170. The memory device 130 (e.g., the local controller 135) or the memory system controller 115 may mark or otherwise designate the data that remains in the old block 170 as invalid or obsolete and may update a logical-to-physical (L2P) mapping table to associate the logical address (e.g., LBA) for the data with the new, valid block 170 rather than the old, invalid block 170. In some cases, such copying and remapping may be performed instead of erasing and rewriting the entire old block 170 due to latency or wear out considerations, for example. In some cases, one or more copies of an L2P mapping table may be stored within the memory cells of the memory device 130 (e.g., within one or more blocks 170 or planes 165) for use (e.g., reference and updating) by the local controller 135 or memory system controller 115.

In some cases, L2P mapping tables may be maintained, and data may be marked as valid or invalid at the page level of granularity, and a page 175 may contain valid data, invalid data, or no data. Invalid data may be data that is outdated, which may be due to a more recent or updated version of the data being stored in a different page 175 of the memory device 130. Invalid data may have been previously programmed to the invalid page 175 but may no longer be associated with a valid logical address, such as a logical address referenced by the host system 105. Valid data may be the most recent version of such data being stored on the memory device 130. A page 175 that includes no data may be a page 175 that has never been written to or that has been erased.

In some cases, a memory system 110 may utilize a memory system controller 115 to provide a managed memory system that may include, for example, one or more memory arrays and related circuitry combined with a local (e.g., on-die or in-package) controller (e.g., local controller 135). An example of a managed memory system is a managed NAND (MNAND) system.

The system 100 may include any quantity of non-transitory computer readable media that supports the use of translation-exempt memory for mode transition. For example, the host system 105 (e.g., a host system controller 106), the memory system 110 (e.g., a memory system controller 115), or a memory device 130 (e.g., a local controller 135) may include or otherwise may access one or more non-transitory computer readable media storing instructions (e.g., firmware, logic, code) for performing the functions ascribed herein to the host system 105, the memory system 110, or a memory device 130. For example, such instructions, if executed by the host system 105 (e.g., by a host system controller 106), by the memory system 110 (e.g., by a memory system controller 115), or by a memory device 130 (e.g., by a local controller 135), may cause the host system 105, the memory system 110, or the memory device 130 to perform associated functions as described herein.

In some examples, operating information for the system 100 may be stored in a volatile memory that is coupled with the host system 105, where operating information for the system 100 may refer to operating information for the host system 105, operating information for the memory system 110, or both. The operating information may include operating information associated with one or more operations (e.g., software application execution, memory management operations, electronic driver management operations, peripheral management operations, maintenance operations, navigation operations) performed by the system 100, operating information associated with (e.g., representative of) the state of the system 100 (also referred to as system state information) or both, among other examples. The volatile memory may be directly accessible by the host system 105 (e.g., without interacting with the memory system 110) but, unlike non-volatile memory, may lose content in the absence of power.

In some examples, the system 100 may enter a suspension state in which one or more operations of the host system 105, the memory system 110, or the entire system 100 are suspended. A system suspension state may occur in one or more modes, such as a low power mode (e.g., a suspend mode) or a maintenance mode in which one or more maintenance operations are performed on the system 100. To preserve the operating information for use after entering a system suspension state, the system 100 may write (e.g., save) the operating information in a non-volatile memory of one or more memory devices 130. In some examples (e.g., if the system 100 is in a suspend mode), the power applied to the host system 105, the memory system 110, or the entire system 100 may be reduced in the suspend mode relative to an active mode in which the one or more operations are performed. If the system 100 is included in a car, the suspend mode may be entered, e.g., when the car is parked or turned off.

Rather than write (e.g., save) the operating information in a translation-based portion of the non-volatile memory, which may refer to a portion of the non-volatile memory that is accessible using address translation, the system 100 may write (e.g., save) the operating information in a translation-exempt portion of the non-volatile memory. Doing so may allow retrieval of the operating information without performance of various initialization sequences that are prerequisites for address translation, which in turn may reduce the latency associated with retrieving the operating information. Address translation may occur at the memory system 110 and may refer to the mapping of logical addresses (e.g., used by the host system 105 for data management) to physical addresses of the non-volatile memory.

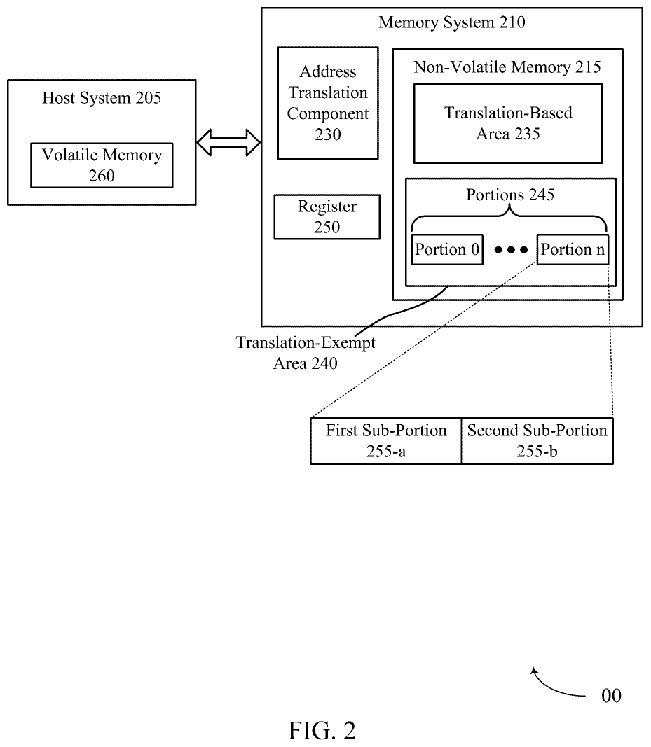

FIG. 2 shows an example of a system 200 that supports the use of translation-exempt memory for mode transition in accordance with examples as disclosed herein. The system 200 may be an example of the system 100 as described with reference to FIG. 1. Accordingly, the system 200 may include a host system 205 and a memory system 210, which may be examples of the respective systems as described with reference to FIG. 1. The memory system 210 may include a non-volatile memory 215 that includes a translation-based area 220 and a translation-exempt area 225. The system 200 may store operating information for the system 200 (e.g., for the host system 205, for the memory system 210, for both) in a portion of the translation-exempt area 225 so that one or more time-consuming initialization sequences associated with address translation can be avoided during retrieval of the operating information.

The host system 205 may be coupled with a volatile memory 260, which may be included in the host system 205 or external to the host system 205, and which may be configured for direct host system-access, where direct host system-access refers to access that does not involve the memory system 210. The host system 205 may use the volatile memory 260 to store operating information that the system 200 (e.g., the host system 205, the memory system 210) uses to perform various operations, manage the state of the system 200, or both. In some examples, the operating information may be or include operating system (OS) information, such as OS RAM information (e.g., applications that are running, resources allocated to different threads and/or processes, etc.), OS kernel information (e.g., kernel image, device drivers resources/initialization details, etc.), and the like, which supports the operation of the system 200. Although the volatile memory 260 may provide fast, direct access to the operating information, the volatile memory 260 may lose the operating information if the system 200 enters a system suspension state.

To prevent loss of the operating information during the system suspension state, the host system 205 may transfer the operating information to the memory system 210 for storage in the non-volatile memory 215. To reduce latency associated with retrieving the operating information (e.g., upon exit from the suspend mode), the host system 205 may instruct the memory system 210 to store the operating information in the translation-exempt area 240 (as opposed to the translation-based area 235). Unlike the translation-based area 235, the memory system 210 may be capable of accessing the translation-exempt area 240 without time-consuming initialization sequences associated with address translation.

The memory system 210 may include an address translation component 230, which may be an example of a Flash Translation Layer (FTL) component, that facilitates address translation between logical addresses and physical addresses (e.g., L2P information). For example, the address translation component 230 may store L2P information (e.g., L2P tables) that maps logical addresses to physical addresses and in some examples may operate on the L2P information to perform address translation. The address translation component 230 may be initialized before use, which may involve loading L2P information from the non-volatile memory 215 into the address translation component 230. In some examples, initialization of the address translation component 230 may rely on (e.g., be based on, be contingent on) initialization of the system 200.

The memory system 210, via the address translation component 230, may use address translation to access the translation-based area 235. For example, if the memory system 210 receives an access command (e.g., a read command, a write command) from the host system 205 that is associated with one or more logical addresses, the memory system 210 may (e.g., via the address translation component 230) use address translation to determine the physical addresses of memory cells to be accessed based on logical addresses. Thus, access commands that target the translation-based area 235 may include logical address information.

Unlike the translation-based area 235, the translation-exempt area 240 may be accessed by the memory system 210 without using address translation (e.g., without using the address translation component 230), and thus may be accessible by the memory system 210 without initialization of the address translation component 230, initialization (or at least re-initialization) of the memory system 200, or both. For instance, the portions 245 (e.g., portion 0 through portion n) of the translation-exempt area 240 may be associated with (e.g., assigned) respective identifiers that are known to both the host system 205 and the memory system 210. Thus, an access command for a portion 245 may include the identifier for a portion 245 and may exclude (e.g., omit) logical address information.

For instance, rather than a write command (which may be used for writing data to the translation-based area 235 and which may indicate logical address information), the system 200 may use an Image Download Command (which may indicate a portion identifier but exclude logical address information) to write data to a portion 245 of the translation-exempt area 240. And rather than a read command (which may be used for reading data from the translation-based area 235 and which may indicate logical address information), the system 200 may use an Image Read Command (which may indicate a portion identifier but exclude logical address information) to read data from a portion 245 of the translation-exempt area 240. In some examples (e.g., if the operating data written to a portion 245 consumes a fraction of the portion 245), the Image Read Command may indicate a size of the operating information stored in the portion 245 (e.g., so that the memory system 210 only reads and transmits valid operating information).

In another example, the system 200 may use the register 250 to prompt the memory system 210 to access the translation-exempt area 240. The register 250 may be associated with the translation-exempt area 240 (or associated with a portion 245) and may have various bits that facilitate accessing the translation-exempt area 240. For example, the register 250 may include one or more bits whose logic values indicate the type of operation (e.g., read, write, move), one or more bits whose logic values indicate the portion 245 to be accessed (e.g., if the register 250 is associated with the translation-exempt area 240 rather than a specific portion 245), or both. In some examples (e.g., if the operating data written to a portion 245 consume a fraction of the portion 245), the register may include one or more bits whose values indicate a size of the operating information stored in the portion 245 (e.g., so that the memory system 210 only reads and transmits valid operating information). The collective logic values of the register bits may be referred to as the state of the register. The logic values of the bits (and thus the state of the register 250) may be modifiable by the host system 205 (e.g., via register commands that indicate logic values for the bits of the register 250).

In some examples, the portions 245 may be configured by the host system 205. For instance, upon initialization of the system 200, the host system 205 may configure the portions 245 (e.g., by indicating a size and identifier for each portion 245). Because the portions 245 are accessible by the memory system 210 without using address translation, the portions 245 may have shorter access times relative to the translation-based area 235, where access time may refer to the time between receiving an indication of an access to be performed and completing the access.

In some examples, a portion 245 may be associated with a write pattern that defines the manner in which operating information is written to the portion 245. For example, the portion 245 may be associated with a sequential write pattern in which operating data is written to sequentially (e.g., consecutively) indexed memory blocks (e.g., with the first-received set of the operating information being written to a memory with a numerically first index and subsequently received sets of the operating information being written to memory blocks with progressively higher indices in order of receipt). Using a consistent write pattern to write operating information to the portions 245 may allow the memory system 210 retrieve the operating information without logical address information (and return the operating information to the host system 205 in the manner expected by the host system 205, which may be in the same order in which the operating system information was received). A portion 245 may also be referred to as a logical unit (LU) or other suitable terminology.

In some examples, a portion 245 may include multiple sub-portions 255 that are written using different types of write operations and which have different endurance and retention attributes. For example, the first sub-portion 255-a (e.g., a high-endurance (HE)-SLC (HE-SLC) portion) may include memory cells written using HE-SLC write operations. And the second sub-portion 255-b may include memory cells written using SLC or MLC write operations. Thus, the first sub-portion 225-a may be associated with higher endurance and lower retention than the second sub-portion 255-b. The endurance of a sub-portion may refer to the quantity of times the sub-portion can be written before being associated with a threshold error rate and the retention of a sub-portion may refer to the amount of time data can be stored in the sub-portion before incurring a threshold quantity of errors.

In some examples, the memory system 210 may initially store operating information in the first sub-portion 255-a, which has high endurance relative to the sub-portion 255-b, to avoid wear-out. However, the first sub-portion 255-a may have lower retention relative to the second sub-portion 255-b. Accordingly, the host system 205 may instruct the memory system 210 to copy the operating information from the first sub-portion 255-a to the second sub-portion 255-b, an operation that may be referred to as a move operation. For example, the host system 205 may transmit a command, such as a Move command, that indicates the memory system 210 is to copy the operating information from the first sub-portion 255-a to the second sub-portion 255-b. The command, such as the Move command, may indicate the portion 245 associated with the first sub-portion 255-a and the second sub-portion 255-b and may exclude logical address information. In an alternative, the host system 205 may use one or more bits in the register 250 to indicate the move operation.

The host system 205 may instruct the memory system 210 to perform a move operation for operating information based on detecting satisfaction of a trigger condition. For example, the host system 205 may instruct the memory system 210 to perform a move operation for operating information based on determining that threshold duration has elapsed since the host system 205 initiated writing of the operating information. The threshold duration may be based on the retention time of the first sub-portion 255-a. Thus, the system 200 may benefit from the endurance attribute of the first sub-portion 255-a as well as the retention attribute of the second sub-portion 255-b, which may improve the performance of the system 200.

Thus, the system 200 may store operating information in a portion of the translation-exempt area 225 so that time-consuming initialization sequences associated with address translation can be avoided during retrieval of the operating information.

Although described with reference to operating information, the techniques described herein may be used to reduce the latency of retrieving other types of information. For example, the system 200 may use the translation-exempt area 240 to store a back-up or emergency operating system for use if the main operating system becomes corrupted or is unavailable (e.g., during system maintenance). In some examples, the back-up operating system may be configured to facilitate the performance of one or more system maintenance operations.

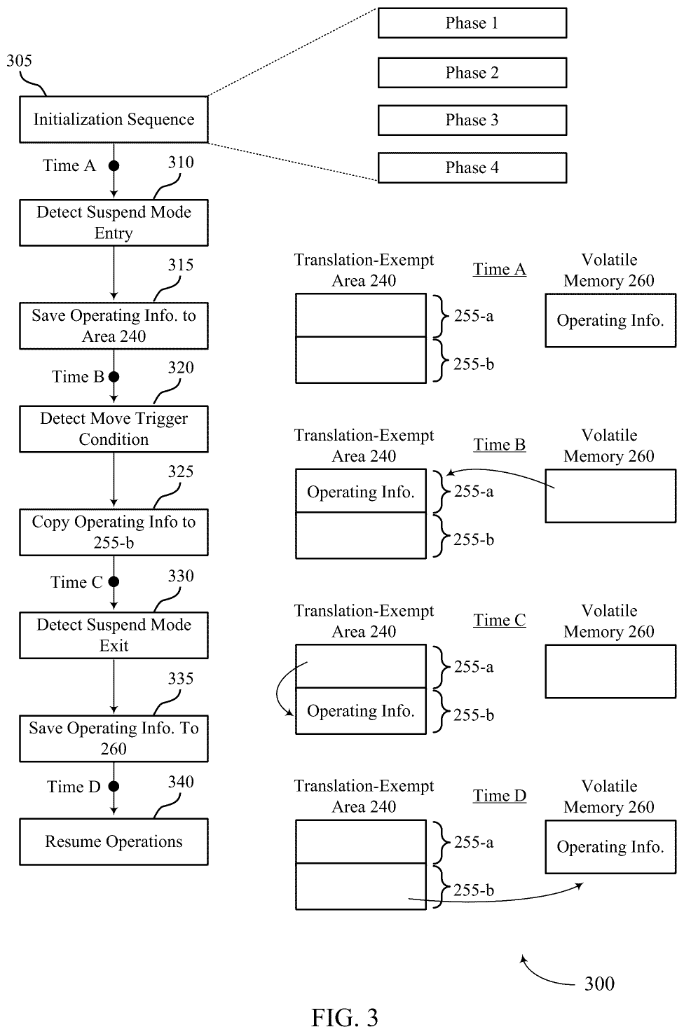

FIG. 3 shows an example of a process flow 300 that supports the use of translation-exempt memory for mode transition in accordance with examples as disclosed herein. The process flow 300 may be implemented by the system 200 as described with reference to FIG. 2. Implementation of the process flow 300 may enable storage of information, such as operating information, in a portion of the translation-exempt area 240 so that time-consuming initialization sequences associated with address translation (e.g., the initialization sequence at 305, a re-initialization sequence of the address translation component 230) can be avoided during retrieval of the operating information.

At 305, the system 200 may perform an initialization sequence, for example, as part of an initial power boot-up procedure or system reset procedure. The initialization sequence may enable operation of the system 200 as well as facilitate the initialization of the address translation component 230. In some examples, the initialization sequence at 305 may include multiple phases, such as Phase 1 through Phase 4, which are described after the description for 310 through 340. After 305, at Time A, operating information for the system 200 may be in the volatile memory 260. The operating information may include information associated with one or more operations of the system 200, information representative of the state of the system 200, OS information (e.g., OS kernal, OS RAM), or any combination thereof.

In some examples, initialization of the address translation component 230 may rely on (e.g., be based on) the initialization of the system 200. Thus, after initialization of the system 200, the memory system 210 may initialize the address translation component 230, which may include loading L2P information from the non-volatile memory into the address translation component 230.

At 310, the system 200 may detect an impending entry into the system suspension state (e.g., the suspend mode, a maintenance mode). For example, if the system 200 is included in a car, the system 200 may detect impending entry into the system suspension state (e.g., the suspend mode, a maintenance mode) based on one or more trigger conditions occurring, such as the car being turned off.

At 315, the system 200 may write (e.g., save) the operating information from the volatile memory 260 to a portion of the translation-exempt area 240. The system 200 may write (e.g., save) the operating information to the translation-exempt area 240 based on determining that the system 200 is going to enter the system suspension state. Thus, after 315, at Time B, the operating information for the system 200 may be in the portion of the translation-exempt area 240 (e.g., in sub-portion 255-a).

At 320, the system 200 may detect that a trigger condition for moving the operating information within the translation-exempt area 240 has been satisfied. For example, the system 200 may determine that a threshold duration has elapsed since the system 200 wrote (e.g., saved) the operating information in the translation-exempt area 240. The threshold duration may be based on (e.g., less than) the retention time of the sub-portion 255-a.

At 325, the system 200 may copy the operating information from the sub-portion 255-a (e.g., an HE-SLC portion) to the sub-portion 255-b (e.g., an SLC portion, an MLC portion). The system may copy the operating information from the sub-portion 255-a to the sub-portion 255-b based on detecting that the trigger condition for moving the operating information has been satisfied. Thus, after 325, at Time C, the operating information may be in the sub-portion 255-b.

At 330, the system 200 may detect exit from the system suspension state (or an impending exit from the system suspension state) e.g., to a different system state (e.g., an active mode or other higher power mode). For instance, if the system 200 is included in a car, the system 200 may detect exit (or an impending exit) from the system suspension state based on the car being turned on.

At 335, the system 200 may write (e.g., save) the operating information from the translation-exempt area 240 to the volatile memory 260. The system 200 may write (e.g., save) the operating information to the volatile memory 260 based on determining that the system 200 is going to exit the system suspension state. Because the operating information is stored in the translation-exempt area 240, the system 200 may retrieve the operating information without re-performing at least some, if not all, operations of the initialization sequence described with reference to 305, without re-initializing the address translation component 230, or both, which may reduce the retrieval latency relative to techniques that store operating information in translation-based memory. Thus, after 335, at Time D, the operating information may be in the volatile memory 260 and ready for direct host-access.

Accordingly, at 340, the system 200 may use the operating information in the volatile memory 260 to resume operations associated with the operating information, manage the state of the system 200, and the like. Thus, implementation of the process flow 300 may enable storage of operating information in the translation-exempt area 240 so that aspects of the initialization sequence at 305, a re-initialization sequence of the address translation component 230, or both, can be avoided during retrieval of the operating information.

Reference is now made to Phase 1 through Phase 4 of the initialization sequence performed at 305. At Phase 1, the host system 205 may retrieve (e.g., from an internal mask ROM) code that facilitates aspects of Phase 1, such as transfer of bootstrap code from non-volatile memory to an internal SRAM of the host system 205. For example, the ROM code may detect various hardware parameters that load the boot code from the non-volatile memory to the internal SRAM. At Phase 2, the bootstrap code may be in the internal SRAM and ready to be executed. Functions of the bootstrap code may include copying the bootloader code from the non-volatile memory 215 to the volatile memory 260 and configuring the host system 205 hardware settings. At Phase 3, the bootloader code may be in the volatile memory 260 and ready for execution. Functions of the bootloader code may include copying the operating system from the non-volatile memory 215 to the volatile memory 260 for a subsequent boot procedure. At Phase 4, the operating system (e.g., OS kernal, OS RAM) may be in the volatile memory 260 and ready for execution to complete the initialization sequence. After Phase 4, the operating system (e.g., as executed by the host system 205) may take control of the system 200.

Alternative examples of the foregoing may be implemented, where some operations are performed in a different order than described, are performed in parallel, are performed serially, or are not performed at all. In some cases, operations may include additional features not mentioned herein, or further operations may be added. Additionally, certain operations may be performed multiple times or certain combinations of operations may repeat or cycle.

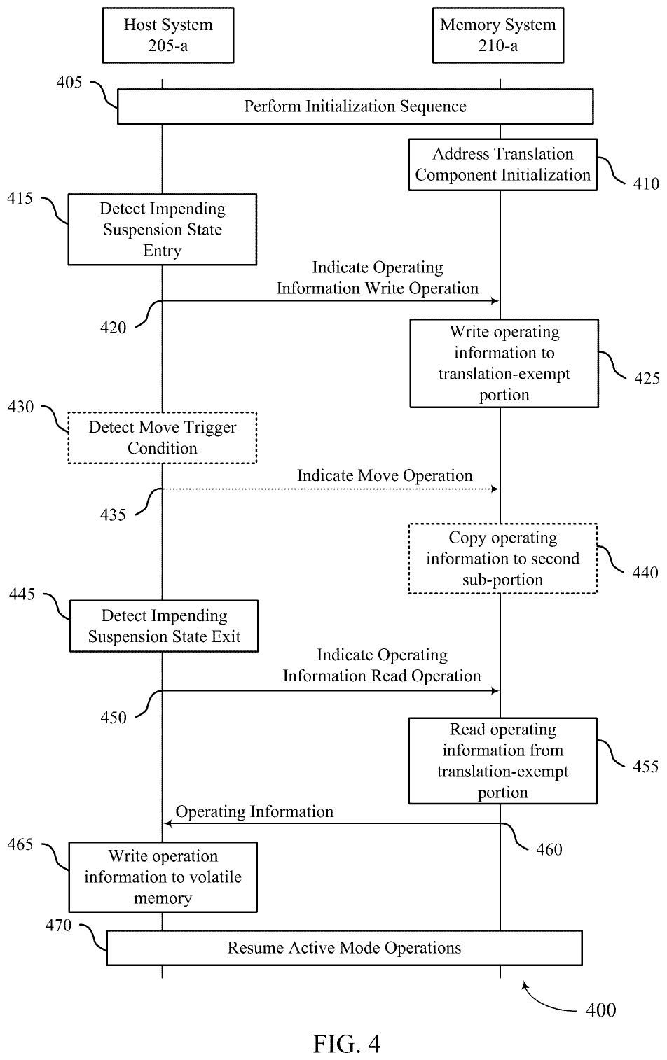

FIG. 4 shows an example of a process flow 400 that supports the use of translation-exempt memory for mode transition in accordance with examples as disclosed herein. The process flow 400 may be implemented by a system such as the system 200 as described with reference to FIG. 2. For example, aspects of the process flow 400 may be implemented by a host system 205-a, which may be (or be an example of) the host system 205 described with reference to FIG. 2. And aspects of the process flow 400 may be implemented by a memory system 210-a, which may be (or be an example of) the memory system 210 described with reference to FIG. 2. Implementation of the process flow 400 may enable reduced latency for retrieval of operating information.

At 405, the host system 205-a and the memory system 210-a may perform an initialization sequence, such as the initialization sequence described with reference to FIG. 3, to initialize the system. After 405, operating information for the system may be stored in a volatile memory of the system (e.g., the volatile memory 260). At 410, the memory system 210-a may perform an initialization procedure for an address translation component (e.g., the address translation component 230) so that the memory system 210-a can perform address translation. The initialization procedure for the address translation component may be based on the initialization sequence for the system.

At 415, the host system 205-a may determine that the system or one or more components of the system (e.g., the host system 205-a, the memory system 210-a) are going to (e.g., within a threshold duration of time) enter a system suspension state (e.g., a suspend mode, a maintenance mode).

At 420, the host system 205-a may, based on determining the impending entry into the system suspension state, indicate that the memory system 210-a is to write the operation information to a translation-exempt portion (e.g., portion n) of a non-volatile memory of the memory system 210-a. The host system 205-a may also transmit the operating information to the memory system 210-a. In some examples, the host system 205-a may indicate the write operation by transmitting an Image Load Command as described herein. In other examples, the host system 205-a may indicate the write operation by transmitting a register command to set the state of a register (e.g., the register 250) to a state associated with writing to the translation-exempt portion. Because writing to the translation-exempt portion can be accomplished by the memory system 210-a without using address translation, the write operation may in some examples be referred to as a translation-exempt write operation.

At 425, the memory system 210-a may, based on the indication at 420, write the operating information to the translation-exempt portion (e.g., portion n) of the non-volatile memory. The memory system 210 may write the operating information without using address translation (e.g., without using the address translation component 230). In some examples, the memory system 210-a may write the operating information to a first sub-portion (e.g., first sub-portion 255-a) of the translation-exempt portion. In some examples, the memory system 210-a may write the operating information in a manner consistent with a write pattern associated with the translation-exempt portion. For example, the memory system 210-a may write the operating information sequentially (e.g., a first-received set of the operating information may be written to a memory block with physical address index k, a second-receive set of operation information may be written to a memory block with physical address index k+1, and so on and so forth).

At 430, the host system 205-a may determine that a trigger condition for moving the operating information within the non-volatile memory has been satisfied. For example, the host system 205-a may determine that a threshold duration has elapsed since performance of an event associated with writing the operating information to the non-volatile memory. Examples of the event may include transmission of the Image Load Command, transmission of the register command to set the state of the register, transmission of the operating information, or receipt of a message indicating successful storage of the operating information in the non-volatile memory.

At 435, the host system 205-a may, based on determining that the trigger condition has been satisfied, indicate that the memory system 210-a is to copy the operating information from the first sub-portion to a second sub-portion (e.g., second sub-portion 255-b) of the translation-exempt portion. The first sub-portion may have higher endurance and lower retention than the second sub-portion. In some examples, the host system 205-a may indicate the move operation by transmitting a Move command as described herein. In other examples, the host system 205-a may indicate the move operation by transmitting a register command to set the state of a register (e.g., the register 250) to a state associated with moving the operating information.

At 440, the memory system 210-a may, based on the indication at 435, copy the operating information from the first sub-portion (e.g., sub-portion 255-a) to the second sub-portion (e.g., sub-portion 255-b).

At 445, the host system 205-a may determine the system or one or more components of the system (e.g., the host system 205-a, the memory system 210-a) have exited the system suspension state or are going to (e.g., within a threshold duration of time) exit the system suspension state.

At 450, the host system 205-a may, based on the determination at 445, indicate that the memory system 210-a is to read the operation information from the translation-exempt portion (e.g., portion n) of the non-volatile memory. In some examples, the host system 205-a may indicate the read operation by transmitting an Image Read Command as described herein. In other examples, the host system 205-a may indicate the read operation by transmitting a register command to set the state of a register (e.g., the register 250) to a state associated with reading from the translation-exempt portion. Because reading from the translation-exempt portion can be accomplished by the memory system 210-a without using address translation, the read operation may in some examples be referred to as a translation-exempt read operation.

At 455, the memory system 210-a may, based on the indication at 450, read the operating information from the translation-exempt portion. The memory system 210 may read the operating information without using address translation (e.g., without using the address translation component 230). Because the memory system 210 is able to read the operating information without using address translation, the memory system 210 may read the operating information without waiting for re-initialization of the system 200, re-initialization of the address translation component, or both, which may reduce the latency of reading the operating information relative to other techniques.

At 460, the memory system 210-a may transmit the operating information to the host system 205-a. At 465, the host system 205-a may write the operating information to the volatile memory. Accordingly, at 470, the system may resume the operations associated with the operating information (e.g., by accessing the operating information in the volatile memory).

Thus, the process flow 400 may enable reduced latency for retrieval of operating information.

Alternative examples of the foregoing may be implemented, where some operations are performed in a different order than described, are performed in parallel, are performed serially, or are not performed at all. In some cases, operations may include additional features not mentioned herein, or further operations may be added. Additionally, certain operations may be performed multiple times or certain combinations of operations may repeat or cycle.

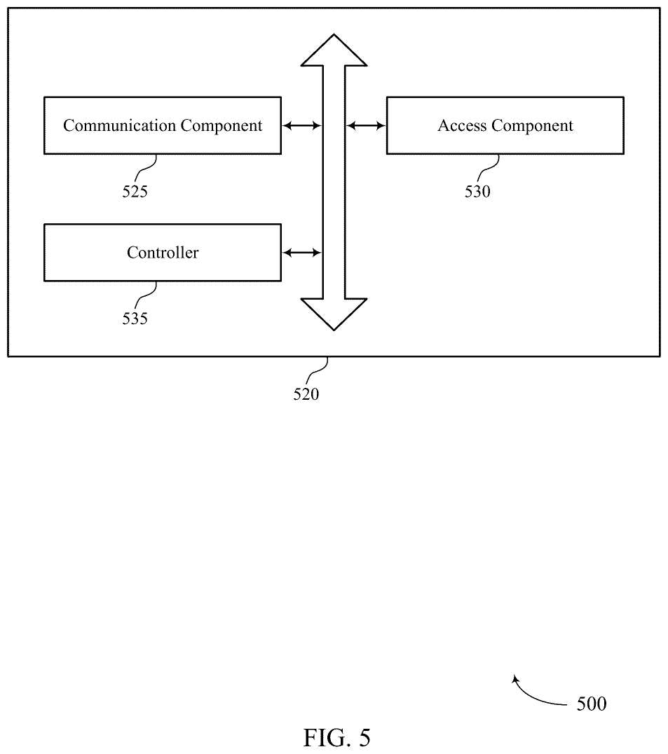

FIG. 5 shows a block diagram 500 of a memory system 520 that supports the use of translation-exempt memory for mode transition in accordance with examples as disclosed herein. The memory system 520 may be an example of aspects of a memory system as described with reference to FIGS. 1 through 4. The memory system 520, or various components thereof, may be an example of means for performing various aspects of use of translation-exempt memory for mode transition as described herein. For example, the memory system 520 may include a communication component 525, an access component 530, a controller 535, or any combination thereof. Each of these components, or components of subcomponents thereof (e.g., one or more processors, one or more memories), may communicate, directly or indirectly, with one another (e.g., via one or more buses).

The communication component 525 may be configured as or otherwise support a means for receiving, by the memory system including a non-volatile memory having a first portion that is accessible by the memory system using address translation, operating information associated with a set of operations of a system that includes the memory system. The access component 530 may be configured as or otherwise support a means for writing, by the memory system before entering a system suspension state in which the set of operations of the system are suspended, the operating information to a second portion, of the non-volatile memory, that is accessible by the memory system without using address translation. The controller 535 may be configured as or otherwise support a means for exiting the system suspension state based on an indication from a host system. In some examples, the communication component 525 may be configured as or otherwise support a means for transmitting, based on exiting the system suspension state, the operating information from the non-volatile memory to the host system.

In some examples, the second portion of the non-volatile memory has a lower access latency than the first portion of the non-volatile memory. In some examples, address translation includes mapping a logical address to a physical address.

In some examples, the operating information is written to a first sub-portion of the second portion, and the communication component 525 may be configured as or otherwise support a means for receiving a command to copy the operating information from the first sub-portion to a second sub-portion of the second portion, where the operating information is transmitted after copying the operating information to the second sub-portion.

In some examples, the first sub-portion includes memory cells associated with a first type of write operation and the second sub-portion includes memory cells associated with a second type of write operation that is associated with a longer retention time than the memory cells of the first sub-portion.

In some examples, the communication component 525 may be configured as or otherwise support a means for receiving a command, for the operating information, that indicates the second portion of the non-volatile memory and that excludes logical address information, where the operating information is transmitted based on the command.

In some examples, the controller 535 may be configured as or otherwise support a means for determining, based on a state of a register associated with the second portion of the non-volatile memory, that the operating information is to be transmitted to the host system, where the operating information is transmitted based on the state of the register.

In some examples, the second portion of the non-volatile memory is associated with a write pattern for writing to the second portion, and the access component 530 may be configured as or otherwise support a means for writing the operating information to the second portion of the non-volatile memory in accordance with the write pattern.

In some examples, the write pattern includes a sequential write pattern in which the operating information is written to memory blocks with sequentially indexed physical addresses.

In some examples, the operating information includes software application information, or system state information, or any combination thereof.

In some examples, the communication component 525 may be configured as or otherwise support a means for receiving, from the host system, a command that identifies the second portion of the non-volatile memory, that excludes logical address information, and that indicates that the operating information is to be written to the second portion of the non-volatile memory, where the operating information is written to the second portion of the non-volatile memory based on the command.

In some examples, the controller 535 may be configured as or otherwise support a means for resuming one or more operations of the set of operations based on transmitting the operating information to the host system. In some examples, the second portion of the non-volatile memory is secured by a password.

In some examples, the access component 530 may be configured as or otherwise support a means for writing, to a third portion of the non-volatile memory that is accessible by the memory system without address translation, back-up operating system information for operating the system.

In some examples, the described functionality of the memory system 520, or various components thereof, may be supported by or may refer to at least a portion of at least one processor, where such at least one processor may include one or more processing elements (e.g., a controller, a microprocessor, a microcontroller, a digital signal processor, a state machine, discrete gate logic, discrete transistor logic, discrete hardware components, or any combination of one or more of such elements). In some examples, the described functionality of the memory system 520, or various components thereof, may be implemented at least in part by instructions (e.g., stored in memory, non-transitory computer-readable medium) executable by such at least one processor.

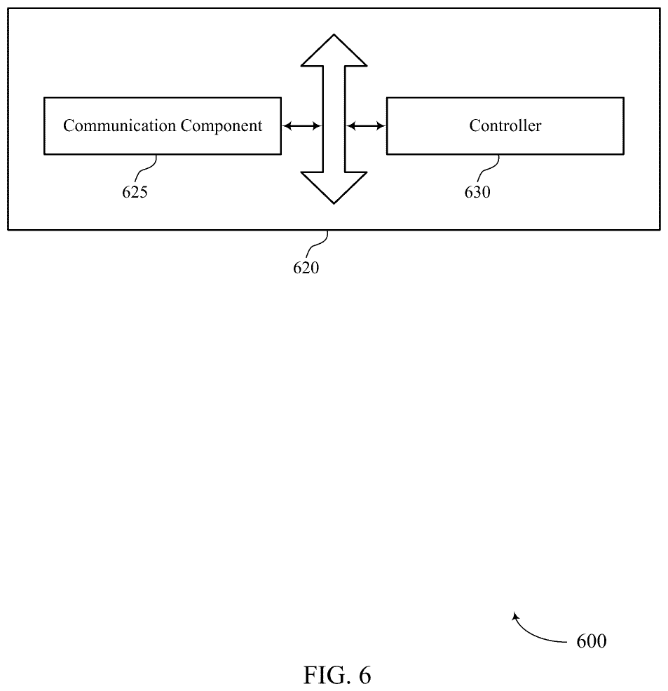

FIG. 6 shows a block diagram 600 of a host system 620 that supports the use of translation-exempt memory for mode transition in accordance with examples as disclosed herein. The host system 620 may be an example of aspects of a host system as described with reference to FIGS. 1 through 4. The host system 620, or various components thereof, may be an example of means for performing various aspects of use of translation-exempt memory for mode transition as described herein. For example, the host system 620 may include a communication component 625 a controller 630, or any combination thereof. Each of these components, or components of subcomponents thereof (e.g., one or more processors, one or more memories), may communicate, directly or indirectly, with one another (e.g., via one or more buses).

The communication component 625 may be configured as or otherwise support a means for transmitting, to a memory system including a non-volatile memory having a first portion that is accessible by the memory system using address translation, operating information associated with a set of operations of the host system. In some examples, the communication component 625 may be configured as or otherwise support a means for indicating, to the memory system based on determining the host system is to enter a system suspension state in which the set of operations are suspended, that the memory system is to write the operating information to a second portion, of the non-volatile memory, that is accessible without using address translation. In some examples, the communication component 625 may be configured as or otherwise support a means for receiving, based on the host system exiting the system suspension state, the operating information from the memory system. The controller 630 may be configured as or otherwise support a means for resuming one or more operations of the set of operations based on the operating information received from the memory system.

In some examples, the communication component 625 may be configured as or otherwise support a means for transmitting a command to copy the operating information from a first sub-portion of the second portion to a second sub-portion of the second portion, where the operating information is transmitted after transmitting the command to copy the operating information.

In some examples, the controller 630 may be configured as or otherwise support a means for determining that a threshold duration has elapsed since transmission of the operating information, where the command to copy the operating information is transmitted based on the determination.

In some examples, the first sub-portion includes memory cells associated with a first type of write operation and the second sub-portion includes memory cells associated with a second type of write operation that is associated with a longer retention time than the memory cells of the first sub-portion.

In some examples, the communication component 625 may be configured as or otherwise support a means for transmitting a command, for the operating information, that indicates the second portion of the non-volatile memory and that excludes logical address information, where the operating information is received based on the command.

In some examples, the communication component 625 may be configured as or otherwise support a means for signaling, to the memory system, a state for a register of the memory system based on determining to exit the system suspension state, where the state indicates that the operating information is to be transmitted to the host system.

In some examples, the communication component 625 may be configured as or otherwise support a means for transmitting, to the memory system in association with transmitting the operating information, a command that identifies the second portion of the non-volatile memory and that indicates that the operating information is to be written to the second portion of the non-volatile memory.

In some examples, the described functionality of the host system 620, or various components thereof, may be supported by or may refer to at least a portion of at least one processor, where such at least one processor may include one or more processing elements (e.g., a controller, a microprocessor, a microcontroller, a digital signal processor, a state machine, discrete gate logic, discrete transistor logic, discrete hardware components, or any combination of one or more of such elements). In some examples, the described functionality of the host system 620, or various components thereof, may be implemented at least in part by instructions (e.g., stored in memory, non-transitory computer-readable medium) executable by such at least one processor.

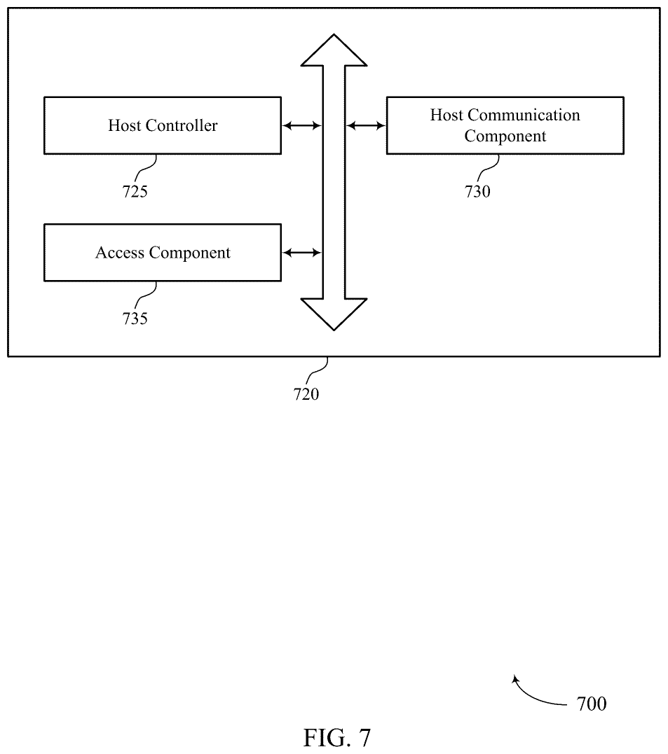

FIG. 7 shows a block diagram 700 of a system 720 that supports the use of translation-exempt memory for mode transition in accordance with examples as disclosed herein. The system 720 may be an example of aspects of a system as described with reference to FIGS. 1 through 4. The system 720, or various components thereof, may be an example of means for performing various aspects of use of translation-exempt memory for mode transition as described herein. For example, the system 720 may include a host controller 725, a host communication component 730, an access component 735, or any combination thereof. Each of these components, or components of subcomponents thereof (e.g., one or more processors, one or more memories), may communicate, directly or indirectly, with one another (e.g., via one or more buses).

The host controller 725 may be configured as or otherwise support a means for determining, by a host system, that the system including the host system and a memory system is to enter a system suspension state in which a set of operations of the system are suspended, the memory system including a non-volatile memory having a first portion that is accessible by the memory system using address translation. The host communication component 730 may be configured as or otherwise support a means for transmitting, by the host system, operating information associated with the set of operations to the memory system based on the determination. The access component 735 may be configured as or otherwise support a means for writing, by the memory system before the system enters the system suspension state, the operating information to a second portion of the non-volatile memory that is accessible by the memory system without using address translation. In some examples, the host communication component 730 may be configured as or otherwise support a means for receiving, from the memory system, the operating information based on the system exiting the system suspension state.

In some examples, the host communication component 730 may be configured as or otherwise support a means for transmitting, by the host system, a command to copy the operating information from a first sub-portion of the second portion to a second sub-portion of the second portion. In some examples, the access component 735 may be configured as or otherwise support a means for copying, by the memory system based on the command, the operating information from the first sub-portion to the second sub-portion, where the operating system information is received after the copying.

In some examples, the host controller 725 may be configured as or otherwise support a means for determining, by the host system, that a threshold duration has elapsed since transmitting the operating information, where the command is transmitted based on determining that the threshold duration has elapsed.

In some examples, the host communication component 730 may be configured as or otherwise support a means for transmitting, by the host system, a command for the operating information that indicates the second portion of the non-volatile memory and that excludes logical address information, where the operating information is received based on the command.

In some examples, the host communication component 730 may be configured as or otherwise support a means for transmitting, by the host system, a command to write the operating information that indicates the second portion of the non-volatile memory and that excludes logical address information, where the operating information is written to the second portion of the non-volatile memory based on the command.

In some examples, the described functionality of the system 720, or various components thereof, may be supported by or may refer to at least a portion of at least one processor, where such at least one processor may include one or more processing elements (e.g., a controller, a microprocessor, a microcontroller, a digital signal processor, a state machine, discrete gate logic, discrete transistor logic, discrete hardware components, or any combination of one or more of such elements). In some examples, the described functionality of the system 720, or various components thereof, may be implemented at least in part by instructions (e.g., stored in memory, non-transitory computer-readable medium) executable by such at least one processor.

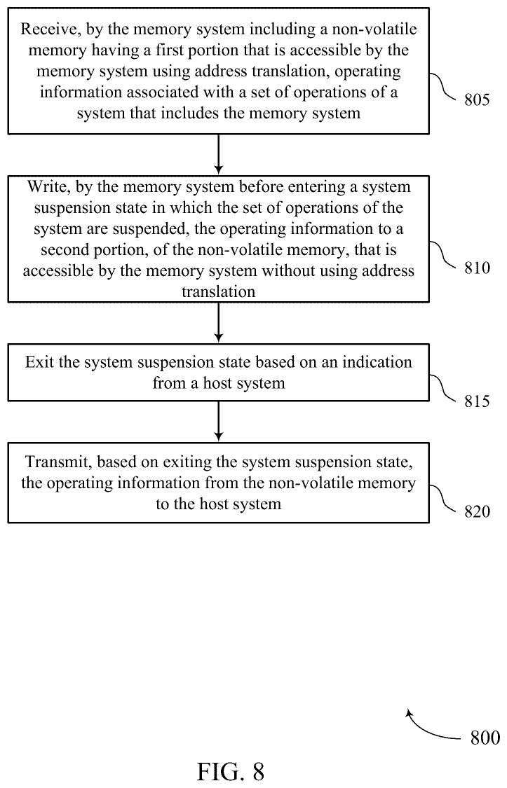

FIG. 8 shows a flowchart illustrating a method 800 that supports the use of translation-exempt memory for mode transition in accordance with examples as disclosed herein. The operations of method 800 may be implemented by a memory system or its components as described herein. For example, the operations of method 800 may be performed by a memory system as described with reference to FIGS. 1 through 5. In some examples, a memory system may execute a set of instructions to control the functional elements of the device to perform the described functions. Additionally, or alternatively, the memory system may perform aspects of the described functions using special-purpose hardware.

At 805, the method may include receiving, by the memory system including a non-volatile memory having a first portion that is accessible by the memory system using address translation, operating information associated with a set of operations of a system that includes the memory system. In some examples, aspects of the operations of 805 may be performed by a communication component 525 as described with reference to FIG. 5.

At 810, the method may include writing, by the memory system before entering a system suspension state in which the set of operations of the system are suspended, the operating information to a second portion, of the non-volatile memory, that is accessible by the memory system without using address translation. In some examples, aspects of the operations of 810 may be performed by an access component 530 as described with reference to FIG. 5.

At 815, the method may include exiting the system suspension state based on an indication from a host system. In some examples, aspects of the operations of 815 may be performed by a controller 535 as described with reference to FIG. 5.

At 820, the method may include transmitting, based on exiting the system suspension state, the operating information from the non-volatile memory to the host system. In some examples, aspects of the operations of 820 may be performed by a communication component 525 as described with reference to FIG. 5.

In some examples, an apparatus as described herein may perform a method or methods, such as the method 800. The apparatus may include features, circuitry, logic, means, or instructions (e.g., a non-transitory computer-readable medium storing instructions executable by a processor), or any combination thereof for performing the following aspects of the present disclosure:

Aspect 1: A method, apparatus, or non-transitory computer-readable medium including operations, features, circuitry, logic, means, or instructions, or any combination thereof for receiving, by the memory system including a non-volatile memory having a first portion that is accessible by the memory system using address translation, operating information associated with a set of operations of a system that includes the memory system; writing, by the memory system before entering a system suspension state in which the set of operations of the system are suspended, the operating information to a second portion, of the non-volatile memory, that is accessible by the memory system without using address translation; exiting the system suspension state based on an indication from a host system; and transmitting, based on exiting the system suspension state, the operating information from the non-volatile memory to the host system.

Aspect 2: The method, apparatus, or non-transitory computer-readable medium of aspect 1, where the second portion of the non-volatile memory has a lower access latency than the first portion of the non-volatile memory and address translation includes mapping a logical address to a physical address.

Aspect 3: The method, apparatus, or non-transitory computer-readable medium of any of aspects 1 through 2, where the operating information is written to a first sub-portion of the second portion and the method, apparatuses, and non-transitory computer-readable medium further includes operations, features, circuitry, logic, means, or instructions, or any combination thereof for receiving a command to copy the operating information from the first sub-portion to a second sub-portion of the second portion, where the operating information is transmitted after copying the operating information to the second sub-portion.

Aspect 4: The method, apparatus, or non-transitory computer-readable medium of aspect 3, where the first sub-portion includes memory cells associated with a first type of write operation and the second sub-portion includes memory cells associated with a second type of write operation that is associated with a longer retention time than the memory cells of the first sub-portion.

Aspect 5: The method, apparatus, or non-transitory computer-readable medium of any of aspects 1 through 4, further including operations, features, circuitry, logic, means, or instructions, or any combination thereof for receiving a command, for the operating information, that indicates the second portion of the non-volatile memory and that excludes logical address information, where the operating information is transmitted based on the command.

Aspect 6: The method, apparatus, or non-transitory computer-readable medium of any of aspects 1 through 5, further including operations, features, circuitry, logic, means, or instructions, or any combination thereof for determining, based on a state of a register associated with the second portion of the non-volatile memory, that the operating information is to be transmitted to the host system, where the operating information is transmitted based on the state of the register.

Aspect 7: The method, apparatus, or non-transitory computer-readable medium of any of aspects 1 through 6, where the second portion of the non-volatile memory is associated with a write pattern for writing to the second portion and the method, apparatuses, and non-transitory computer-readable medium further includes operations, features, circuitry, logic, means, or instructions, or any combination thereof for writing the operating information to the second portion of the non-volatile memory in accordance with the write pattern.

Aspect 8: The method, apparatus, or non-transitory computer-readable medium of aspect 7, where the write pattern includes a sequential write pattern in which the operating information is written to memory blocks with sequentially indexed physical addresses.

Aspect 9: The method, apparatus, or non-transitory computer-readable medium of any of aspects 1 through 8, where the operating information includes software application information, or system state information, or any combination thereof.

Aspect 10: The method, apparatus, or non-transitory computer-readable medium of any of aspects 1 through 9, further including operations, features, circuitry, logic, means, or instructions, or any combination thereof for receiving, from the host system, a command that identifies the second portion of the non-volatile memory, that excludes logical address information, and that indicates that the operating information is to be written to the second portion of the non-volatile memory, where the operating information is written to the second portion of the non-volatile memory based on the command.

Aspect 11: The method, apparatus, or non-transitory computer-readable medium of any of aspects 1 through 10, further including operations, features, circuitry, logic, means, or instructions, or any combination thereof for resuming one or more operations of the set of operations based on transmitting the operating information to the host system.

Aspect 12: The method, apparatus, or non-transitory computer-readable medium of any of aspects 1 through 11, where the second portion of the non-volatile memory is secured by a password.

Aspect 13: The method, apparatus, or non-transitory computer-readable medium of any of aspects 1 through 12, further including operations, features, circuitry, logic, means, or instructions, or any combination thereof for writing, to a third portion of the non-volatile memory that is accessible by the memory system without address translation, back-up operating system information for operating the system.

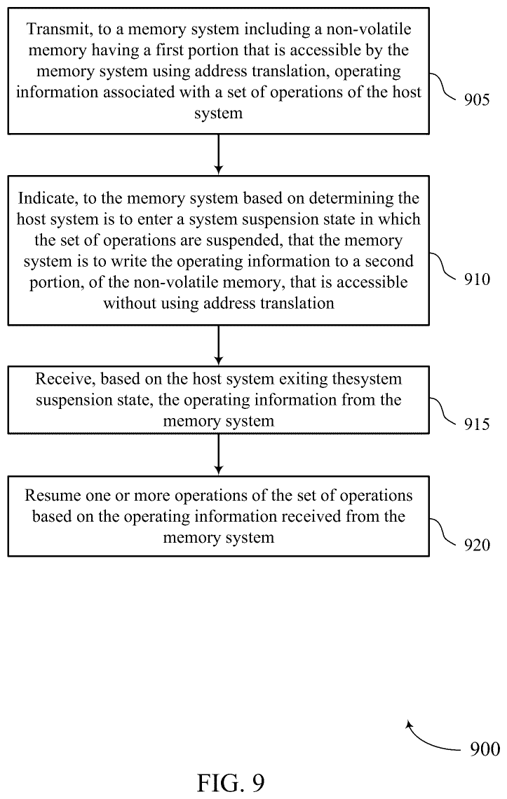

FIG. 9 shows a flowchart illustrating a method 900 that supports the use of translation-exempt memory for mode transition in accordance with examples as disclosed herein. The operations of method 900 may be implemented by a host system or its components as described herein. For example, the operations of method 900 may be performed by a host system as described with reference to FIGS. 1 through 4 and 6. In some examples, a host system may execute a set of instructions to control the functional elements of the device to perform the described functions. Additionally, or alternatively, the host system may perform aspects of the described functions using special-purpose hardware.

At 905, the method may include transmitting, to a memory system including a non-volatile memory having a first portion that is accessible by the memory system using address translation, operating information associated with a set of operations of the host system. In some examples, aspects of the operations of 905 may be performed by a communication component 625 as described with reference to FIG. 6.

At 910, the method may include indicating, to the memory system based on determining the host system is to enter a system suspension state in which the set of operations are suspended, that the memory system is to write the operating information to a second portion, of the non-volatile memory, that is accessible without using address translation. In some examples, aspects of the operations of 910 may be performed by a communication component 625 as described with reference to FIG. 6.

At 915, the method may include receiving, based on the host system exiting the system suspension state, the operating information from the memory system. In some examples, aspects of the operations of 915 may be performed by a communication component 625 as described with reference to FIG. 6.

At 920, the method may include resuming one or more operations of the set of operations based on the operating information received from the memory system. In some examples, aspects of the operations of 920 may be performed by a controller 630 as described with reference to FIG. 6.

In some examples, an apparatus as described herein may perform a method or methods, such as the method 900. The apparatus may include features, circuitry, logic, means, or instructions (e.g., a non-transitory computer-readable medium storing instructions executable by a processor), or any combination thereof for performing the following aspects of the present disclosure:

Aspect 14: A method, apparatus, or non-transitory computer-readable medium including operations, features, circuitry, logic, means, or instructions, or any combination thereof for transmitting, to a memory system including a non-volatile memory having a first portion that is accessible by the memory system using address translation, operating information associated with a set of operations of the host system; indicating, to the memory system based on determining the host system is to enter a system suspension state in which the set of operations are suspended, that the memory system is to write the operating information to a second portion, of the non-volatile memory, that is accessible without using address translation; receiving, based on the host system exiting the system suspension state, the operating information from the memory system; and resuming one or more operations of the set of operations based on the operating information received from the memory system.

Aspect 15: The method, apparatus, or non-transitory computer-readable medium of aspect 14, further including operations, features, circuitry, logic, means, or instructions, or any combination thereof for transmitting a command to copy the operating information from a first sub-portion of the second portion to a second sub-portion of the second portion, where the operating information is transmitted after transmitting the command to copy the operating information.

Aspect 16: The method, apparatus, or non-transitory computer-readable medium of aspect 15, further including operations, features, circuitry, logic, means, or instructions, or any combination thereof for determining that a threshold duration has elapsed since transmission of the operating information, where the command to copy the operating information is transmitted based on the determination.

Aspect 17: The method, apparatus, or non-transitory computer-readable medium of any of aspects 15 through 16, where the first sub-portion includes memory cells associated with a first type of write operation and the second sub-portion includes memory cells associated with a second type of write operation that is associated with a longer retention time than the memory cells of the first sub-portion.

Aspect 18: The method, apparatus, or non-transitory computer-readable medium of any of aspects 14 through 17, further including operations, features, circuitry, logic, means, or instructions, or any combination thereof for transmitting a command, for the operating information, that indicates the second portion of the non-volatile memory and that excludes logical address information, where the operating information is received based on the command.

Aspect 19: The method, apparatus, or non-transitory computer-readable medium of any of aspects 14 through 18, further including operations, features, circuitry, logic, means, or instructions, or any combination thereof for signaling, to the memory system, a state for a register of the memory system based on determining to exit the system suspension state, where the state indicates that the operating information is to be transmitted to the host system.

Aspect 20: The method, apparatus, or non-transitory computer-readable medium of any of aspects 14 through 19, further including operations, features, circuitry, logic, means, or instructions, or any combination thereof for transmitting, to the memory system in association with transmitting the operating information, a command that identifies the second portion of the non-volatile memory and that indicates that the operating information is to be written to the second portion of the non-volatile memory.

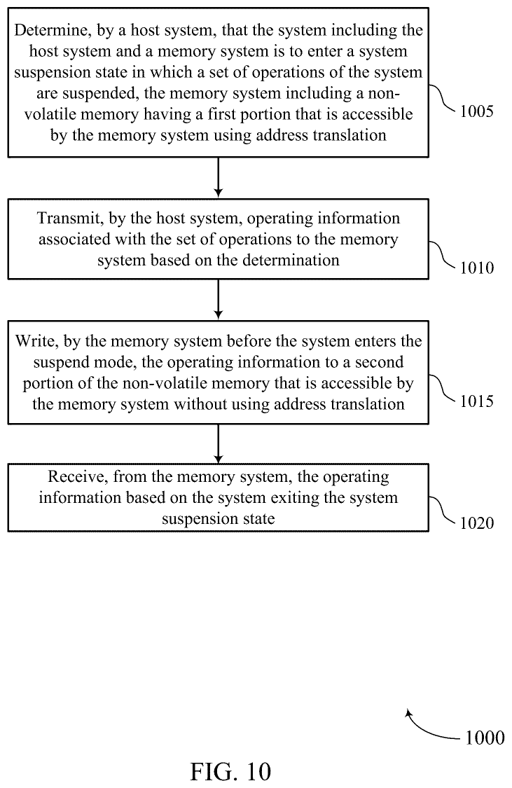

FIG. 10 shows a flowchart illustrating a method 1000 that supports the use of translation-exempt memory for mode transition in accordance with examples as disclosed herein. The operations of method 1000 may be implemented by a system or its components as described herein. For example, the operations of method 1000 may be performed by a system as described with reference to FIGS. 1 through 4 and 7. In some examples, a system may execute a set of instructions to control the functional elements of the device to perform the described functions. Additionally, or alternatively, the system may perform aspects of the described functions using special-purpose hardware.

At 1005, the method may include determining, by a host system, that the system including the host system and a memory system is to enter a system suspension state in which a set of operations of the system are suspended, the memory system including a non-volatile memory having a first portion that is accessible by the memory system using address translation. In some examples, aspects of the operations of 1005 may be performed by a host controller 725 as described with reference to FIG. 7.

At 1010, the method may include transmitting, by the host system, operating information associated with the set of operations to the memory system based on the determination. In some examples, aspects of the operations of 1010 may be performed by a host communication component 730 as described with reference to FIG. 7.

At 1015, the method may include writing, by the memory system before the system enters the system suspension state, the operating information to a second portion of the non-volatile memory that is accessible by the memory system without using address translation. In some examples, aspects of the operations of 1015 may be performed by an access component 735 as described with reference to FIG. 7.

At 1020, the method may include receiving, from the memory system, the operating information based on the system exiting the system suspension state. In some examples, aspects of the operations of 1020 may be performed by a host communication component 730 as described with reference to FIG. 7.

In some examples, an apparatus as described herein may perform a method or methods, such as the method 1000. The apparatus may include features, circuitry, logic, means, or instructions (e.g., a non-transitory computer-readable medium storing instructions executable by a processor), or any combination thereof for performing the following aspects of the present disclosure:

Aspect 21: A method, apparatus, or non-transitory computer-readable medium including operations, features, circuitry, logic, means, or instructions, or any combination thereof for determining, by a host system, that the system including the host system and a memory system is to enter a system suspension state in which a set of operations of the system are suspended, the memory system including a non-volatile memory having a first portion that is accessible by the memory system using address translation; transmitting, by the host system, operating information associated with the set of operations to the memory system based on the determination; writing, by the memory system before the system enters the system suspension state, the operating information to a second portion of the non-volatile memory that is accessible by the memory system without using address translation; and receiving, from the memory system, the operating information based on the system exiting the system suspension state.

Aspect 22: The method, apparatus, or non-transitory computer-readable medium of aspect 21, further including operations, features, circuitry, logic, means, or instructions, or any combination thereof for transmitting, by the host system, a command to copy the operating information from a first sub-portion of the second portion to a second sub-portion of the second portion and copying, by the memory system based on the command, the operating information from the first sub-portion to the second sub-portion, where the operating system information is received after the copying.

Aspect 23: The method, apparatus, or non-transitory computer-readable medium of aspect 22, further including operations, features, circuitry, logic, means, or instructions, or any combination thereof for determining, by the host system, that a threshold duration has elapsed since transmitting the operating information, where the command is transmitted based on determining that the threshold duration has elapsed.

Aspect 24: The method, apparatus, or non-transitory computer-readable medium of any of aspects 21 through 23, further including operations, features, circuitry, logic, means, or instructions, or any combination thereof for transmitting, by the host system, a command for the operating information that indicates the second portion of the non-volatile memory and that excludes logical address information, where the operating information is received based on the command.

Aspect 25: The method, apparatus, or non-transitory computer-readable medium of any of aspects 21 through 24, further including operations, features, circuitry, logic, means, or instructions, or any combination thereof for transmitting, by the host system, a command to write the operating information that indicates the second portion of the non-volatile memory and that excludes logical address information, where the operating information is written to the second portion of the non-volatile memory based on the command.

It should be noted that the described techniques include possible implementations, and that the operations and the steps may be rearranged or otherwise modified and that other implementations are possible. Further, portions from two or more of the methods may be combined.

Information and signals described herein may be represented using any of a variety of different technologies and techniques. For example, data, instructions, commands, information, signals, bits, or symbols of signaling that may be referenced throughout the above description may be represented by voltages, currents, electromagnetic waves, magnetic fields or particles, optical fields or particles, or any combination thereof. Some drawings may illustrate signals as a single signal; however, the signal may represent a bus of signals, where the bus may have a variety of bit widths.

The terms “electronic communication,” “conductive contact,” “connected,” and “coupled” may refer to a relationship between components that supports the flow of signals between the components. Components are considered in electronic communication with (or in conductive contact with or connected with or coupled with) one another if there is any conductive path between the components that can, at any time, support the flow of signals between the components. At any given time, the conductive path between components that are in electronic communication with each other (or in conductive contact with or connected with or coupled with) may be an open circuit or a closed circuit based on the operation of the device that includes the connected components. The conductive path between connected components may be a direct conductive path between the components or the conductive path between connected components may be an indirect conductive path that may include intermediate components, such as switches, transistors, or other components. In some examples, the flow of signals between the connected components may be interrupted for a time, for example, using one or more intermediate components such as switches or transistors.

The term “coupling” (e.g., “electrically coupling”) may refer to a condition of moving from an open-circuit relationship between components in which signals are not presently capable of being communicated between the components over a conductive path to a closed-circuit relationship between components in which signals are capable of being communicated between components over the conductive path. If a component, such as a controller, couples other components together, the component initiates a change that allows signals to flow between the other components over a conductive path that previously did not permit signals to flow.

The term “isolated” refers to a relationship between components in which signals are not presently capable of flowing between the components. Components are isolated from each other if there is an open circuit between them. For example, two components separated by a switch that is positioned between the components are isolated from each other if the switch is open. If a controller isolates two components, the controller affects a change that prevents signals from flowing between the components using a conductive path that previously permitted signals to flow.

As used herein, the term “substantially” means that the modified characteristic (e.g., a verb or adjective modified by the term substantially) need not be absolute but is close enough to achieve the advantages of the characteristic.

The terms “if,” “when,” “based on,” or “based at least in part on” may be used interchangeably. In some examples, if the terms “if,” “when,” “based on,” or “based at least in part on” are used to describe a conditional action, a conditional process, or connection between portions of a process, the terms may be interchangeable.

The term “in response to” may refer to one condition or action occurring at least partially, if not fully, as a result of a previous condition or action. For example, a first condition or action may be performed and second condition or action may at least partially occur as a result of the previous condition or action occurring (whether directly after or after one or more other intermediate conditions or actions occurring after the first condition or action).

Additionally, the terms “directly in response to” or “in direct response to” may refer to one condition or action occurring as a direct result of a previous condition or action. In some examples, a first condition or action may be performed and second condition or action may occur directly as a result of the previous condition or action occurring independent of whether other conditions or actions occur. In some examples, a first condition or action may be performed and second condition or action may occur directly as a result of the previous condition or action occurring, such that no other intermediate conditions or actions occur between the earlier condition or action and the second condition or action or a limited quantity of one or more intermediate steps or actions occur between the earlier condition or action and the second condition or action. Any condition or action described herein as being performed “based on,” “based at least in part on,” or “in response to” some other step, action, event, or condition may additionally, or alternatively (e.g., in an alternative example), be performed “in direct response to” or “directly in response to” such other condition or action unless otherwise specified.

The devices discussed herein, including a memory array, may be formed on a semiconductor substrate, such as silicon, germanium, silicon-germanium alloy, gallium arsenide, gallium nitride, etc. In some examples, the substrate is a semiconductor wafer. In some other examples, the substrate may be a silicon-on-insulator (SOI) substrate, such as silicon-on-glass (SOG) or silicon-on-sapphire (SOP), or epitaxial layers of semiconductor materials on another substrate. The conductivity of the substrate, or sub-regions of the substrate, may be controlled through doping using various chemical species including, but not limited to, phosphorus, boron, or arsenic. Doping may be performed during the initial formation or growth of the substrate, by ion-implantation, or by any other doping means.

A switching component or a transistor discussed herein may represent a field-effect transistor (FET) and comprise a three terminal device including a source, drain, and gate. The terminals may be connected to other electronic elements through conductive materials, e.g., metals. The source and drain may be conductive and may comprise a heavily-doped, e.g., degenerate, semiconductor region. The source and drain may be separated by a lightly-doped semiconductor region or channel. If the channel is n-type (i.e., majority carriers are electrons), then the FET may be referred to as an n-type FET. If the channel is p-type (i.e., majority carriers are holes), then the FET may be referred to as a p-type FET. The channel may be capped by an insulating gate oxide. The channel conductivity may be controlled by applying a voltage to the gate. For example, applying a positive voltage or negative voltage to an n-type FET or a p-type FET, respectively, may result in the channel becoming conductive. A transistor may be “on” or “activated” if a voltage greater than or equal to the transistor's threshold voltage is applied to the transistor gate. The transistor may be “off” or “deactivated” if a voltage less than the transistor's threshold voltage is applied to the transistor gate.

The description set forth herein, in connection with the appended drawings, describes example configurations and does not represent all the examples that may be implemented or that are within the scope of the claims. The term “exemplary” used herein means “serving as an example, instance, or illustration” and not “preferred” or “advantageous over other examples.” The detailed description includes specific details to provide an understanding of the described techniques. These techniques, however, may be practiced without these specific details. In some instances, well-known structures and devices are shown in block diagram form to avoid obscuring the concepts of the described examples.

In the appended figures, similar components or features may have the same reference label. Further, various components of the same type may be distinguished by following the reference label by a hyphen and a second label that distinguishes among the similar components. If just the first reference label is used in the specification, the description is applicable to any one of the similar components having the same first reference label irrespective of the second reference label.

The functions described herein may be implemented in hardware, software executed by a processing system (e.g., one or more processors, one or more controllers, control circuitry processing circuitry, logic circuitry), firmware, or any combination thereof. If implemented in software executed by a processing system, the functions may be stored on or transmitted over as one or more instructions (e.g., code) on a computer-readable medium. Due to the nature of software, functions described herein can be implemented using software executed by a processing system, hardware, firmware, hardwiring, or combinations of any of these. Features implementing functions may be physically located at various positions, including being distributed such that portions of functions are implemented at different physical locations.

Illustrative blocks and modules described herein may be implemented or performed with one or more processors, such as a DSP, an ASIC, an FPGA, discrete gate logic, discrete transistor logic, discrete hardware components, other programmable logic device, or any combination thereof designed to perform the functions described herein. A processor may be an example of a microprocessor, a controller, a microcontroller, a state machine, or other types of processor. A processor may also be implemented as at least one of one or more computing devices (e.g., a combination of a DSP and a microprocessor, multiple microprocessors, one or more microprocessors in conjunction with a DSP core, or any other such configuration).

As used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, electrically erasable programmable read-only memory (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk, and Blu-ray disc, where disks usually reproduce data magnetically, while discs reproduce data optically with lasers. Combinations of these are also included within the scope of computer-readable media.

The description herein is provided to enable a person skilled in the art to make or use the disclosure. Various modifications to the disclosure will be apparent to those skilled in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A method by a memory system, comprising:
receiving, by the memory system comprising a non-volatile memory having a first portion that is accessible by the memory system using address translation, operating information associated with a set of operations of a system that includes the memory system;
writing, by the memory system before entering a system suspension state in which the set of operations of the system are suspended, the operating information to a second portion, of the non-volatile memory, that is accessible by the memory system without using address translation;
exiting the system suspension state based on an indication from a host system; and
transmitting, based on exiting the system suspension state, the operating information from the second portion of the non-volatile memory to the host system.

2. The method of claim 1, wherein the second portion of the non-volatile memory has a lower access latency than the first portion of the non-volatile memory, and address translation comprises mapping a logical address to a physical address.

3. The method of claim 1, wherein the operating information is written to a first sub-portion of the second portion, the method further comprising:
receiving a command to copy the operating information from the first sub-portion to a second sub-portion of the second portion, wherein the operating information is transmitted after copying the operating information to the second sub-portion.

4. The method of claim 3, wherein the first sub-portion comprises memory cells associated with a first type of write operation and the second sub-portion comprises memory cells associated with a second type of write operation that is associated with a longer retention time than the memory cells of the first sub-portion.

5. The method of claim 1, further comprising:
receiving a command, for the operating information, that indicates the second portion of the non-volatile memory and that excludes logical address information, wherein the operating information is transmitted based on the command.

6. The method of claim 1, further comprising:
determining, based on a state of a register associated with the second portion of the non-volatile memory, that the operating information is to be transmitted to the host system, wherein the operating information is transmitted based on the state of the register.

7. The method of claim 1, wherein the second portion of the non-volatile memory is associated with a write pattern for writing to the second portion, the method further comprising:
writing the operating information to the second portion of the non-volatile memory in accordance with the write pattern.

8. The method of claim 7, wherein the write pattern comprises a sequential write pattern in which the operating information is written to memory blocks with sequentially indexed physical addresses.

9. The method of claim 1, wherein the operating information comprises software application information, or system state information, or any combination thereof.

10. The method of claim 1, further comprising:
receiving, from the host system, a command that identifies the second portion of the non-volatile memory, that excludes logical address information, and that indicates that the operating information is to be written to the second portion of the non-volatile memory, wherein the operating information is written to the second portion of the non-volatile memory based on the command.

11. The method of claim 1, further comprising:
resuming one or more operations of the set of operations based on transmitting the operating information to the host system.

12. The method of claim 1, wherein the second portion of the non-volatile memory is secured by a password.

13. The method of claim 1, further comprising:
writing, to a third portion of the non-volatile memory that is accessible by the memory system without address translation, back-up operating system information for operating the system.

14. A method by a host system, comprising:
transmitting, to a memory system comprising a non-volatile memory having a first portion that is accessible by the memory system using address translation, operating information associated with a set of operations of the host system;
indicating, to the memory system based on determining the host system is to enter a system suspension state in which the set of operations are suspended, that the memory system is to write the operating information to a second portion, of the non-volatile memory, that is accessible without using address translation;
receiving, based on the host system exiting the system suspension state, the operating information from the memory system; and
resuming one or more operations of the set of operations based on the operating information received from the memory system.

15. The method of claim 14, further comprising:
transmitting a command to copy the operating information from a first sub-portion of the second portion to a second sub-portion of the second portion, wherein the operating information is transmitted after transmitting the command to copy the operating information.

16. The method of claim 15, further comprising:
determining that a threshold duration has elapsed since transmission of the operating information, wherein the command to copy the operating information is transmitted based on the determination.

17. The method of claim 15, wherein the first sub-portion comprises memory cells associated with a first type of write operation and the second sub-portion comprises memory cells associated with a second type of write operation that is associated with a longer retention time than the memory cells of the first sub-portion.

18. The method of claim 14, further comprising:
transmitting a command, for the operating information, that indicates the second portion of the non-volatile memory and that excludes logical address information, wherein the operating information is received based on the command.

19. The method of claim 14, further comprising:
signaling, to the memory system, a state for a register of the memory system based on determining to exit the system suspension state, wherein the state indicates that the operating information is to be transmitted to the host system.

20. The method of claim 14, further comprising:
transmitting, to the memory system in association with transmitting the operating information, a command that identifies the second portion of the non-volatile memory and that indicates that the operating information is to be written to the second portion of the non-volatile memory.

21. A method by a system, comprising:
determining, by a host system, that the system including the host system and a memory system is to enter a system suspension state in which a set of operations of the system are suspended, the memory system comprising a non-volatile memory having a first portion that is accessible by the memory system using address translation;
transmitting, by the host system, operating information associated with the set of operations to the memory system based on the determination;
writing, by the memory system before the system enters the system suspension state, the operating information to a second portion of the non-volatile memory that is accessible by the memory system without using address translation; and
receiving, from the memory system, the operating information based on the system exiting the system suspension state.

22. The method of claim 21, further comprising:
transmitting, by the host system, a command to copy the operating information from a first sub-portion of the second portion to a second sub-portion of the second portion; and
copying, by the memory system based on the command, the operating information from the first sub-portion to the second sub-portion, wherein the operating system information is received after the copying.

23. The method of claim 22, further comprising:
determining, by the host system, that a threshold duration has elapsed since transmitting the operating information, wherein the command is transmitted based on determining that the threshold duration has elapsed.

24. The method of claim 21, further comprising:
transmitting, by the host system, a command for the operating information that indicates the second portion of the non-volatile memory and that excludes logical address information, wherein the operating information is received based on the command.

25. The method of claim 21, further comprising:
transmitting, by the host system, a command to write the operating information that indicates the second portion of the non-volatile memory and that excludes logical address information, wherein the operating information is written to the second portion of the non-volatile memory based on the command.
